(19) United States
(12) Patent Application Publication
(10) Pub. No.: US 2002/0165031 A1
(43) Pub. Date: Nov. 7, 2002

(54) Steering column shaft assembly having trunion pin retention features

(76) Inventor: Richard Kremer Riefe, Saginaw, MI (US)

Correspondence Address: EDMUND P. ANDERSON, DELPHI TECHNOLOGIES, INC., Legal Staff, Mail Code: 480-414-5052, P.O. Box 5052, Troy, MI, 48007-5052, US

(21) Appl. No.: 09/836,846

(22) Filed: Apr. 17, 2001

(51) Int. Cl. F16D 3/26; F16D 3/50

(52) U.S. Cl. 464/112

(57) ABSTRACT

A steering column shaft assembly for an automotive vehicle includes an upper shaft and a lower shaft coupled by a universal joint having a yoke secured to one of the shaft ends and a cage pivoted to the other shaft end and accommodated within the yoke. The yoke and cage have aligned bores in which a set of trunion pins are received to provide a pivot connection between the yoke and cage. The portion of the trunion pins received in the yoke bores are formed with screw threads that engage threaded walls of the bores. The bores of the cage are unthreaded and receive unthreaded bearing portions of the trunion pins. The threaded connection between the trunion pins and yoke support the trunion pins against axial movement and ejection from the bores during operation of the shaft assembly, particularly under heavy torsional loads. Mechanical interference structure may also be provided to act on the trunion pins to prevent their rotation and thus removal once installed.

### BACKGROUND OF THE INVENTION

1. Technical Field

This invention relates generally to automotive steering column shaft assemblies used to connect the steering wheel of a vehicle to the steering gear mechanism, and more particularly to the construction of the universal joint used to couple upper and lower shaft sections of the assembly.

2. Related Prior Art

Shaft assemblies for automotive steering columns typically include upper and lower shaft sections coupled by a universal joint to accommodate angulation of the shaft assembly.

A typical joint construction for such shaft assemblies is illustrated in FIG. 1 and includes a yoke 10 coupled to an end of the upper shaft 11. The yoke 10 has a cylindrical wall 12 defining a cavity 13 in which a cage 14 is received. The cage 14 has a socket 15 in which an end of the lower shaft 16 is received. A cross pin 17 couples the lower shaft end 16 to the cage 14, permitting articulation of the lower shaft 16 about an axis of the cross pin 17. The yoke 10 of the upper shaft 11 is also pivoted to the cage 14 about a transverse axis by trunion pins 18. The pins 18 are received in aligned bores 19, 20 of the yoke 10 and cage 14, respectively. The yoke bore 19 is sized for a press-fit connection with the trunion pins 18, whereas the cage bores 20 are slightly oversized to provide a journalled bearing connection between the cage 14 and trunion pins 18.

Under extreme torque loads, the assembly may flex sufficiently to cause contact between the end of the lower shaft 16 within the socket 15 and the ends of the trunion pins 18, forcing the pins 18 outwardly toward ejection from the bores 19, 20. The trunion pins 18 rely on their press-fit connection with the yoke bores 19 to resist such ejection loads. Other known means used in lieu of press-fitting to retain the trunion pins 18 include staking over the metal yoke material against the trunion pins 18 and employing an external retaining band acting between the trunion pins 18 and yoke bores 19 to resist axial outward ejection of the pins under torsional loads of the lower shaft end 16.

The steering shaft column assembly according to the invention provides a more effective means of retaining the trunion pins in the yoke to provide greater resistance to ejection of the pins under heavy torsional loading of the joint.

### SUMMARY OF THE INVENTION

An automotive steering column assembly according to the invention includes first and second shaft members having adjacent ends coupled by a universal joint. The universal joint includes a yoke fixed to one of the ends and a cage disposed within the yoke and having walls defining a socket of the cage in which the end of the other shaft is received and retained therein by a pivot connection that enables articulated movement of the other shaft in a plane about an axis of the pivot connection relative to the cage. The yoke and cage are formed with coaxially aligned bores extending along an axis transverse to the axis of the pivot connection. The bores walls of the cage are nonthreaded, whereas those of the yoke are threaded. A pair of trunion pins are received in the aligned bores for coupling the yoke pivotally to the cage to enable the associated shaft member to articulate about the axis of the trunion pins in a plane transverse to that of the plane of movement of the other shaft member. The portion of the trunion pins received in the bores of the cage are nonthreaded, whereas the portion of the trunion pins received in the yoke bores are threaded and engage the threaded walls of the yoke bores. The engagement of the threads serves to restrain the trunion pins against relative axial movement in the bores, thereby increasing the axial holding force of the trunion pins under severe torsional loading of the joint.

The invention has the advantage of providing a highly effective means of securing the trunion pins of a steering column shaft assembly joint against ejection under extreme torsional loading of the joint.

Another advantage of the present invention is that the trunion pins can be easily assembled without extensive modification of the existing production process. The trunion pins can be simply threaded into place.

Another advantage of the invention is that it eliminates the press-fit operation and close tolerance requirements of the known press fit trunion pins in favor of a simple screw thread connection, thereby simplifying the process while providing a high integrity joint.

The invention may optionally include additional mechanical interference structure to prevent rotation of the trunion pins once installed, further lending to the integrity of the subject invention. Such anti-rotation structure may include, for example, adhesives or plastics screw lock materials provided at the thread joint to secure the trunion pins against rotation, deformation of the yoke material through staking or spinning over onto the trunnion pins to preclude rotation, mismatching the thread leads of the trunion pins relative to the threaded bore walls to prevent reverse rotation of the trunion pins, providing a retaining ring or rings between the trunion pins and yoke in addition to the threads, and welding the screw-threaded trunion pins to the yoke.

### BRIEF DESCRIPTION OF THE DRAWINGS

Presently preferred embodiments of the invention are disclosed in the following description and in the accompanying drawings, wherein:

FIG. 1 is a cross-sectional view through the joint of a prior art steering column shaft assembly;

FIG. 2 is an exploded perspective view if a steering column shaft assembly according to the invention;

FIG. 3 is an enlarged cross-sectional view taken along lines 3-3 of FIG. 2 with the components shown in their assembled condition;

FIG. 4 is an enlarged cross-sectional view taken along lines 4-4 of FIG. 2 with the components shown in their assembled condition;

FIG. 5 is an enlarged cross-sectional view of the trunion pin connection of FIG. 4 showing employment of a plastics thread lock material;

FIG. 6 is a view like FIG. 5 but showing an alternative stake-over retention of the trunion pins;

FIG. 7 is a view like FIG. 5 but showing an alternative spin-over retention of the trunion pins;

FIG. 8 is a view like FIG. 5 but showing an alternative bolt head retention of the trunion pins;

FIG. 9 is a view like FIG. 5 but showing an alternative mismatched thread structure for retaining the trunion pins against rotation; and

FIG. 10 is a view like FIG. 5 but showing an alternative weld joint structure for retaining the trunion pins against rotation.

### DETAILED DESCRIPTION

An automotive steering column shaft assembly constructed according to the invention is shown generally at 30 in FIGS. 2-4 and comprises a first upper steering shaft member 32 having a coupled end 34 and a free end 36, and a second lower steering shaft member 38 having a coupled end 40 and a free end 42. The shaft members 32, 38 are rigid members fabricated of steel or the like and the assembly 30 forms part of an overall steering column assembly (not shown) extending between and coupling the steering wheel (not shown) of a vehicle to the steering gear mechanism on the axle (not shown) of the vehicle at a location remote from the steering wheel such that the shaft assembly 30 provides a mechanical steering linkage therebetween.

The coupled ends 34, 40 of the shaft members 32, 38 are joined by a universal or Cardan joint 44 to provide steered conjoint rotation of the coupled shaft members 32, 38 through an angle at the joint 40.

The joint 44 includes a yoke 46 that is fixed to the coupled end 34 of the first shaft 32. The yoke 46 may be formed as one piece with the upper shaft member 32, or may be formed separately therefrom and subsequently joined by welding, a splined connection, or other suitable means for securing the yoke 46 against rotational and axial movement relative to the upper shaft member 32 so as to act as an integral part thereof.

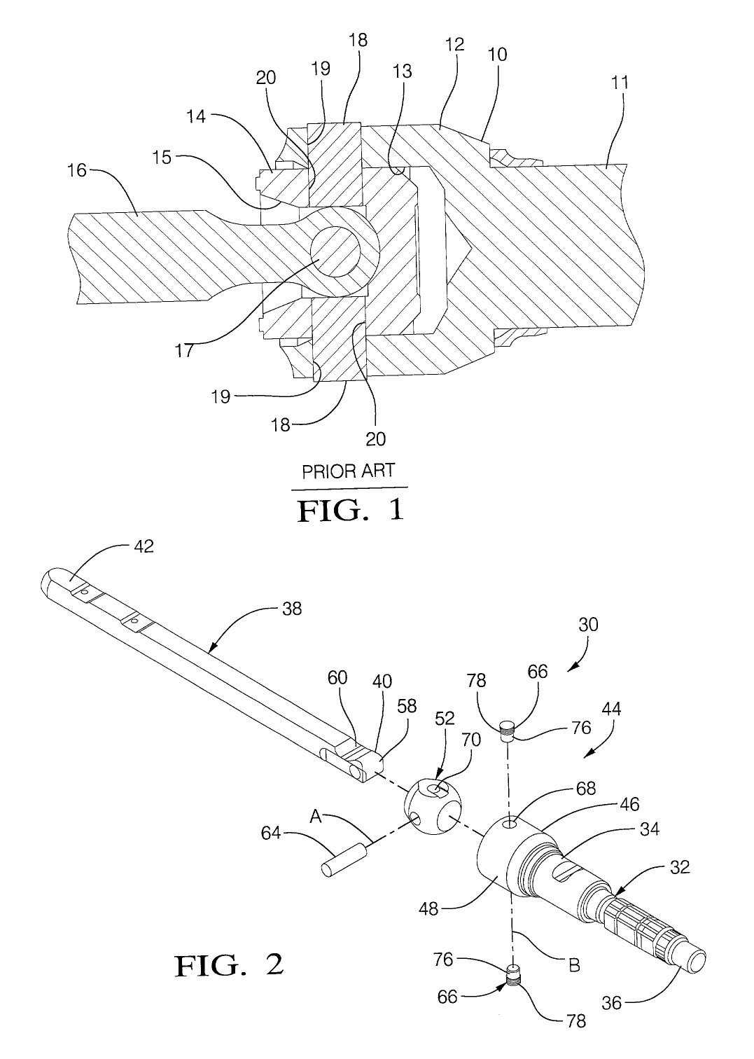

The yoke 46 has laterally spaced sidewalls 48 forming a hollow end or cavity 50 in the free end of the yoke 46. As shown best in FIG. 1, the walls 48 may take the form of a generally cylindrical wall portion of a yoke 46 defiing the open-ended cavity 50 therein.

The joint 44 further includes a cage 52 disposed within the cavity 50 of the yoke 46 and having sidewalls 54 defining an open-ended socket 56 of the cage 52. The coupled end 40 of the lower shaft member 38 is received in the socket 56. The end 40 has a generally cylindrical end surface 58 that closely compliments a corresponding cylindrical portion 60 of the cavity 50. The end 40 also has a narrowed neck region 60 behind the cylindrical head 58. The socket 56 has a widened outwardly divergent mouth region 62 adjacent the neck 60. A cross pin 64 extends through aligned openings in the shaft end 40 and cage 52 to provide a pivot connection between the shaft end 40 and cage 52 to permit articulated movement of the lower shaft member 38 relative to the cage 52 in a plane about an axis A of the cross pin 64. The shaft member 38 is restrained against other movement relative to the cage 52.

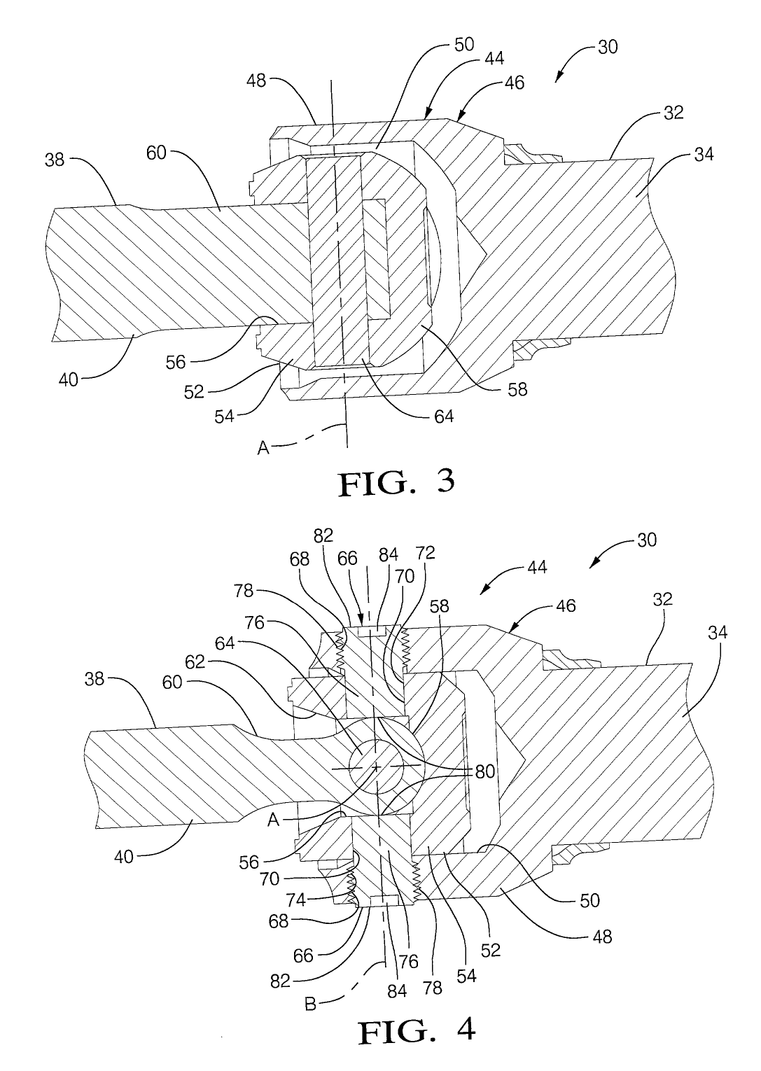

As shown best in FIG. 3, the cross pin 64 is received within the cavity 50 of the yoke 46 and restrained against removal at its opposite ends by the sidewalls 48 of the yoke 46.

As shown best in FIGS. 2 and 4, the joint 44 further includes a set of trunion pins 66 that are received in axially aligned bores 68, 70 of the yoke 46 and cage 52, respectively. The bore 70 of the cage 52 are of predetermined diameter and have a smooth, cylindrical, unthreaded bore wall 72 that extends through the sidewall 54 of the cage 52 and is open to the socket 56 of the cage 52.

The bores 68 of the yoke 46 have threaded bore walls 74 of the same diameter or greater than that of the unthreaded bore wall 72 of the cage bores 70, with the roof of the bore wall threads 74 being greater in diameter than that of the unthreaded bore walls 72 of the cage. The bores 68, 70 lie along an axis B that is transverse in preferably perpendicular to the axis A of the cross pin 64 and arranged in intersecting relation thereto.

The trunion pins 66 have an unthreaded, smooth bearing portion 76 and an enlarged threaded retaining portion 78. The unthreaded portions 76 are accommodated in the bores 70 of the cage 52 and are slightly undersized to provide rotatable bearing support to the unthreaded walls 72 of the cage 52. The radially inner ends 80 of the trunion pins 66 are flush with the sidewalls 54 of the cage cavity 50, and are in close proximity to the cylindrical head 58 on the end of the lower shaft 40 received in the cavity 50.

The threaded end 78 of the trunion pins 66 is disposed within the yoke bore 68 in threaded engagement with the threaded bore walls 74. The engagement of the threads secures the trunion pins 66 against axial movement relative to the yoke 46. The trunion pins 66 are installed by extending the unthreaded end 76 of the pins 66 into the aligned bores 68, 70 and then rotatably driving each trunion pin 66 to the desired depth through mating of the screw threads to establish a pivot connection between the yoke 46 and cage 52, enabling the upper shaft 32 to articulate in a plane about the pivot axis B of the trunion pin 66. The outer exposed end face 82 of the trunion pins 66 are formed with a tool-engaging recess 84 to accommodate the installation of the trunion pins 66. The recess 84 may have any of a number of tool-engaging configurations, including slotted, phillips, torx, hexigonal, etc. to coincide with the requirements of the particular installation tool employed.

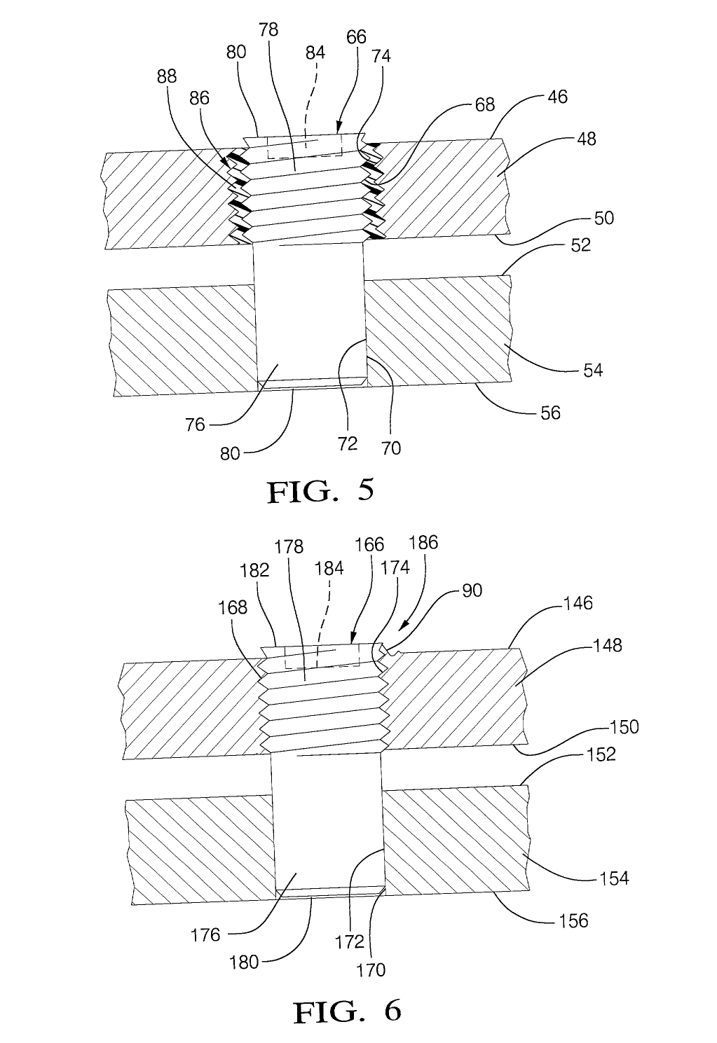

Referring now to FIGS. 5-10, the joint 44 may further include mechanical interference structure 86 acting on the trunion pins 66 to secure them against rotation in the direction of removal following installation. According to the first embodiment of FIG. 5, the mechanical anti-rotation interference structure 86 comprises thread lock material which may include curable liquid adhesives or a deformable plastics liner 88 provided in the thread joint to secure the trunion pins 66 against rotation within the bore 68, 70 during operation of the shaft assembly 30, even under extreme torsional loading conditions. Under such extreme torsional loading conditions, the head 58 of the lower shaft end 40 may engage and bear against the inner end face 80 of one or both trunion pins 66, exerting an axially outward force on one or both pins 66. The engagement of the threads 78, 74 supports the pins 66 against axial movement unless ejection from the bore 68, 70 under such loads. Articulation of the yoke 46 relative to the cage 52 and the corresponding articulation of the trunion pins 66 within the cage bores 70 may further exert a rotational force on the trunion pins 66. The mechanical interference structure 86 of the various embodiments of FIGS. 5-10, and presently the anti-rotation adhesive or liner 88 of FIG. 5, prevents such rotation of the trunion pins 66, assuring that once installed, there is no rotational or axial movement of the trunion pin 66 relative to the yoke 46 under all operating conditions of the shaft assembly 30.

FIG. 6 shows an alternative embodiment of the mechanical interference structure, wherein the same reference numerals are used to represent like structure with respect to the first embodiment, but are offset by 100. The mechanical interference structure 186 of FIG. 6 takes the form of stake-over deformation 90 of the yoke material 146 radially against the trunion pins 166 to effectively damage the threads and lock the trunion pins 166 against rotational and axial movement relative to the yoke 146.

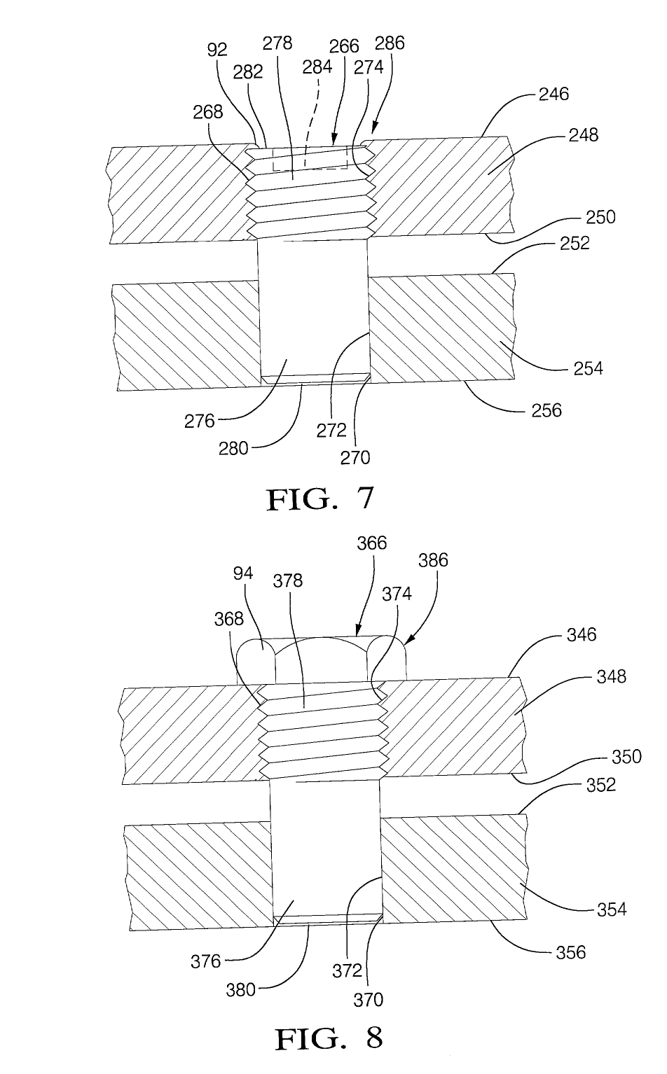

FIG. 7 shows a third embodiment of the anti-rotation structure 286, wherein like reference numerals are used to represent like features to those of the first embodiment, that are offset by 200. In this embodiment, the trunion pins 266 are secured against rotation by spinning or deforming a lip 92 of the yoke material of the yoke bore wall 274 radially inwardly over the end face 282 of the trunion pins 266, locking the trunion pins 266 against removal from the bores 268, 270.

FIG. 8 shows a fourth embodiment of the invention in which the same reference numerals are again used to represent like features, but are offset by 300. It will be seen that the mechanical interference structure 86 is in the form of a fastener head 94 formed on the outer end of the trunion pins 366 (effectively bolts) which, when the trunion pins 366 are tightened, bear against the outer surface of the yoke 46 to impart axial tension and frictional resistance to the removal of the trunion pins 366 once installed.

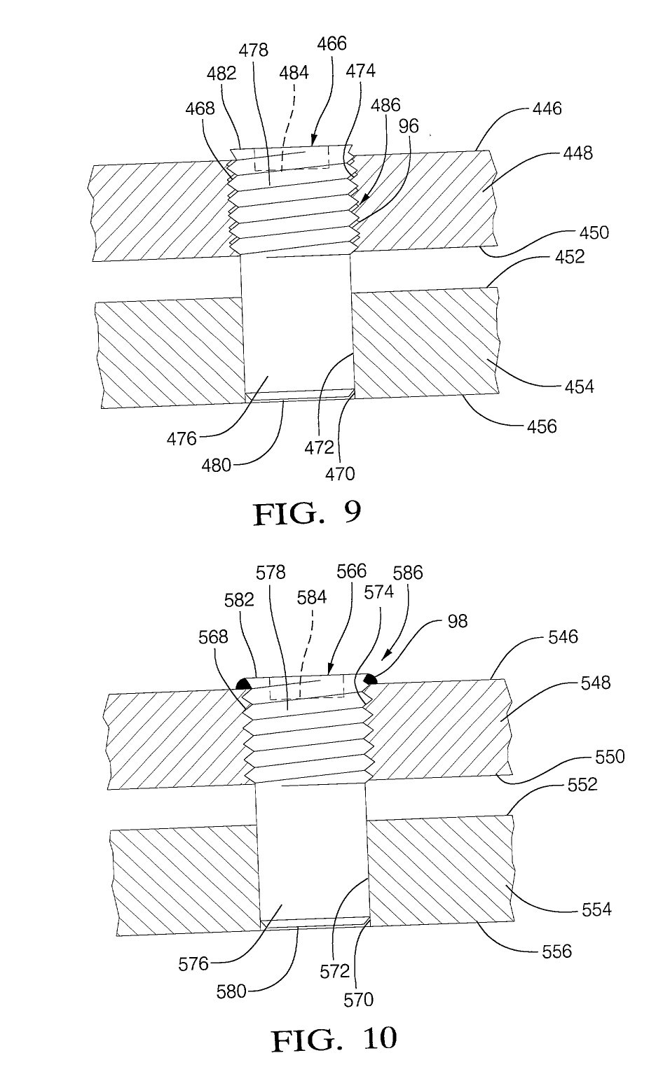

FIG. 9 illustrates a fifth embodiment in which the same reference numerals are used to represent like features with respect to the first embodiment but are offset by 400. The mechanical interference structure 486 takes the form of mismatched threads 94 of the trunion pins 466 and yoke bores 468, requiring forced installation of the trunion pins 466 and frictional resistance to removal. The interfering thread structure 94 may be provided by mismatching the thread leads or providing other interfering deformations or features on the mating threads to impart axial tension and resistance to rotation once mated.

FIG. 10 illustrates a sixth embodiment of the invention in which the same reference numerals are used but are offset by 500 to represent like features with respect to the first embodiment. The mechanical interference structure 586 of FIG. 10 takes the form of a weld joint 98 bridging the trunion pins 586 and the yoke material 546, securing the trunion pins 566 against rotation and thus axial movement relative to the yoke 546. Of course, those skilled in the art will appreciate that there are numerous other approaches that are equivalent in function, way and result to those described above for securing the trunion pins against removal once installed and particularly against reverse rotation and may include, for example, retaining rings, retaining pins, or any other structure or device that would serve to secure the trunion pins against rotation once installed to prevent ejection of the trunion pins during operation of the shaft assembly.

The disclosed embodiments are representative of presently preferred forms of the invention, but are intended to be illustrative rather than definitive thereof. The invention is defined in the claims.

What is claimed is:

1. An automotive steering column shaft assembly comprising:
an upper shaft member having an end;
a lower shaft member having an end adjacent said end of said upper shaft member;
a universal joint coupling said joints together, said joint including a yoke fixed to one of said ends having laterally spaced walls, a cage disposed within said yoke having walls defining a socket, the other of said ends being disposed within said socket and retained therein by a pivot connection enabling the associated shaft member to articulate in a plane about an axis of said pivot connection relative to said cage;
a pair of coaxially aligned bores having non-threaded bore walls extending through said cage and into said socket along an axis transverse to said axis of said pivot connection;
a pair of associated bores formed in said yoke having threaded bore walls; and
a pair of trunion pins disposed in said bores along said axis thereof in such manner as to couple said yoke pivotally to said cage to enable the associated shaft member to articulate in a plane transverse to the plane of the other shaft member about an axis of said trunion pins, said trunion pins having a non-threaded bearing portion accommodated within said bores of said cage, and a threaded retaining portion received within and engaging said threaded bore walls of said yoke to restrain said trunion pins against axial movement within said bores.

2. The assembly of claim 1 including mechanical interference structure acting to restrain said trunion pins against rotation within said bores.

3. The assembly of claim 2 wherein said mechanical interference structure comprises an adhesive applied to said threads of said trunion pins.

4. The assembly of claim 2 wherein said mechanical interference structure comprises a plastics thread lock material acting between said threads of said pinions and said threaded walls of said bore.

5. The assembly of claim 2 wherein said mechanical interference structure comprises mechanical staking of said trunion pins.

6. The assembly of claim 2 wherein said mechanical interference structure comprises material of said yoke spin over said trunion pins to block their outward movement.

7. The assembly of claim 2 wherein said mechanical interference structure comprises a head on said trunion pins tightened against said yoke.

8. The assembly of claim 2 wherein said mechanical interference structure comprises interfering thread patterns of said trunion pins and said bore walls of said yoke.

9. The assembly of claim 2 wherein said mechanical interference structure comprises a weld joint bridging said trunion pins and said yoke.

10. The assembly of claim 1 wherein said non-threaded ends of said trunion pins are engagable by said other shaft and received in said socket of said cage under high torsional loads causing an outward axial load to be imparted on said trunion pins by said other end.

11. The assembly of claim 1 wherein said pivot connection of said cage is provided by a cross pin and said axis of said trunion pins intersects said axis of said cross pin.
